(19) United States
(12) Patent Application Publication
(10) Pub. No.: US 2026/0371170 A1
(43) Pub. Date: Nov. 19, 2026

(54) SATELLITE ROUTING APPARATUS CONSIDERING IMBALANCED TRAFFIC DISTRIBUTION AND DISTRIBUTED ROUTING METHOD THEREOF

(71) Applicant: INDUSTRY-UNIVERSITY COOPERATION FOUNDATION HANYANG UNIVERSITY ERICA CAMPUS, Ansan-si (KR)

(72) Inventors: Sunghyun CHO, Seoul (KR); Joohyun OH, Ansan-si Gyeonggi-do (KR); Joohan PARK, Suwon-si Gyeonggi-do (KR); Sejong LEE, Ansan-si Gyeonggi-do (KR); Yongseok KWON, Hwaseong-si Gyeonggido (KR); Soohyeong KIM, Ansan-si Gyeonggi-do (KR); Jiseung YOUN, Sejong (KR); Donghyun KIM, Ansan-si Gyeonggi-do (KR)

(73) Assignee: INDUSTRY-UNIVERSITY COOPERATION FOUNDATION HANYANG UNIVERSITY ERICA CAMPUS, Ansan-si (KR)

(21) Appl. No.: 19/708,606

(22) Filed: Jun. 15, 2026

Related U.S. Application Data
(63) Continuation of application No. PCT/KR2024/096903, filed on Dec. 13, 2024.

(30) Foreign Application Priority Data
Dec. 13, 2023 (KR) 10-2023-0180902

(51) Int. Cl. H04W 28/08; H04L 47/125; H04W 40/18; H04W 40/20; H04W 84/06

(52) U.S. Cl. CPC H04W 28/0975; H04L 47/125; H04W 40/18; H04W 40/205; H04W 84/06

(57) ABSTRACT

The satellite routing apparatus includes a satellite transceiver configured to transmit and receive a data packet, and a satellite router configured to determine a next satellite to which the data packet is to be transmitted and to transmit the data packet, wherein the satellite router generates a routing table of a satellite by assigning a weight to an inter-satellite link according to a predicted traffic flow, and determines whether to detour the data packet by checking a state of a buffer queue in a next-hop direction to which the data packet is to be transmitted using the routing table.

### CROSS-REFERENCE TO RELATED APPLICATION

This application is a bypass continuation of pending PCT International Application No. PCT/KR2025/096903, which was filed on Dec. 13, 2024, and which claims priority to and the benefit of Korean Patent Application No. 10-2023-0180902, filed on Dec. 13, 2023, the disclosures of which are incorporated herein by reference in their entirety.

### BACKGROUND

### 1. Field of the Invention

The embodiments disclosed in the present disclosure relate to a satellite routing apparatus for distributing an overload acting on a satellite due to an imbalanced traffic distribution, and to a distributed routing method thereof.

### 2. Discussion of Related Art

A low Earth orbit (LEO) satellite network refers to a network system in which a plurality of low Earth orbit satellites are arranged at an altitude of about 700 km to 2,000 km, which is lower than 36,000 km corresponding to a typical geostationary satellite orbit, and mobile communication services can be provided anywhere in the world by communicating with user equipment (UE) on the ground. The low Earth orbit satellite network is an alternative technology to conventional terrestrial network technologies capable of supporting wide coverage and obtaining high-speed communication rates, and is also a next-generation network technology for which various countries and companies are competitively conducting research and development. Such a low Earth orbit satellite network may provide communication services to remote areas, mountainous areas, oceans, and the like, where terrestrial network infrastructure is insufficient, through multi-hop routing.

However, in a low Earth orbit satellite network, an imbalance in traffic distribution may occur in each of the satellites due to geographical characteristics, such as densely populated areas. In this case, a satellite located in an area where traffic distribution is concentrated may cause an overload in the use of satellite resources due to excessive use of a link for communicating with another satellite, that is, an inter-satellite link (ISL), and may cause a problem of loss of data packets.

In addition, a low Earth orbit satellite network periodically transmits and receives data packets including related information to and from neighboring satellites in order to distribute load on the satellites. Accordingly, there has been a problem in that the low Earth orbit satellite network wastes network resources to be used for transmitting actual data, because network management information for overload distribution, rather than actual data, is transmitted and received.

Meanwhile, the above-described background art is technical information that the inventor possessed for deriving the present invention or acquired in the course of deriving the present invention, and thus may not necessarily be regarded as known art that was disclosed to the general public before the filing of the present invention.

### SUMMARY OF THE INVENTION

The embodiments disclosed in the present disclosure provide a satellite routing apparatus capable of distributing an overload of a satellite located in an area where traffic distribution is concentrated, and a distributed routing method thereof.

The embodiments disclosed in the present disclosure provide a satellite routing apparatus for minimizing transmission of related information for distributing an overload of a satellite, and a distributed routing method thereof.

As technical means for achieving the above-described technical problem, according to one embodiment, a satellite routing apparatus includes: a satellite transceiver configured to transmit and receive a data packet; and a satellite router configured to determine a next satellite to which the data packet is to be transmitted and to transmit the data packet, wherein the satellite router generates a routing table of a satellite by assigning weights to inter-satellite links according to a predicted traffic flow, and determines whether to detour the data packet by checking a state of a buffer queue in a next-hop direction to which the data packet is to be transmitted using the routing table.

According to another embodiment, a distributed routing method of a satellite routing apparatus includes: generating a topology graph of a satellite network; predicting a traffic flow to be transmitted through the satellite network; updating, in the topology graph, a weight for each inter-satellite link to a queueing delay time of the inter-satellite link calculated based on the traffic flow; generating a routing table of each satellite; when a data packet is received, identifying a best next-hop satellite (BH) and a second-best next-hop satellite (SBH) for a destination satellite; and determining a next satellite to which the data packet is to be transmitted by checking an occupancy rate of a buffer queue, and transmitting the data packet.

According to any one of the above-described means for solving the problems, an overload of a satellite located in an area where traffic distribution is concentrated may be distributed.

According to any one of the above-described means for solving the problems, transmission of related information for distributing an overload of a satellite may be minimized.

According to any one of the above-described means for solving the problems, end-to-end delay of data packets may be reduced, and a loss rate of the data packets may be minimized.

The effects obtainable from the present invention are not limited to the effects mentioned above, and other effects not mentioned herein will be clearly understood by those skilled in the art from the following description.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a block diagram illustrating a satellite system according to one embodiment.

FIG. 2 is a diagram illustrating generation of a network topology according to a satellite constellation according to one embodiment.

FIG. 3 is a diagram illustrating, as a network topology, a satellite constellation connected by inter-satellite links according to one embodiment.

FIG. 4 is a diagram illustrating traffic distribution density values of surface areas according to one embodiment.

FIG. 5 is a diagram illustrating selection of a best next-hop satellite and a second-best next-hop satellite according to one embodiment.

FIG. 6 is a flowchart illustrating a distributed routing operation in a routing apparatus according to one embodiment.

FIG. 7 is a graph illustrating an average packet loss rate of packets arriving at a destination while varying a packet generation rate according to one embodiment.

FIG. 8 is a graph illustrating throughput of packet data while varying a packet generation rate according to one embodiment.

FIG. 9 is a graph illustrating an average end-to-end delay of packets while varying a packet generation rate according to one embodiment.

FIG. 10 is a graph illustrating an average queueing delay of packets arriving at a destination while varying a packet generation rate according to one embodiment.

FIG. 11 is a graph illustrating an average end-to-end delay of all packets while varying a packet generation rate according to one embodiment.

FIG. 12 is a graph illustrating a distribution index while varying a packet generation rate according to one embodiment.

FIG. 13 is a graph illustrating an average end-to-end delay of packet flows between major cities in the world according to one embodiment.

### DETAILED DESCRIPTION OF EXEMPLARY EMBODIMENTS

Hereinafter, various embodiments will be described in detail with reference to the accompanying drawings. The embodiments described below may be modified and implemented in various different forms. In order to more clearly describe the features of the embodiments, detailed descriptions of matters widely known to those skilled in the art to which the following embodiments pertain are omitted. In addition, portions unrelated to the description of the embodiments are omitted from the drawings, and like reference numerals are assigned to like portions throughout the present disclosure.

Throughout the present disclosure, when an element is described as being “connected” to another element, this includes not only a case in which the element is “directly connected” to the other element, but also a case in which the element is “connected to the other element with another element interposed therebetween.” In addition, when an element is described as “including” another element, this means that the element may further include other elements, rather than excluding such other elements, unless otherwise specifically stated.

Before describing the embodiments with reference to the accompanying drawings, terms to be described below will be briefly explained.

Although the satellite described below is explained based on a low Earth orbit (LEO) satellite, the satellite may include a satellite located in an orbit other than a low Earth orbit, and may include various other satellites or flying objects located in an orbit of a planet. In addition, in order to describe a routing operation, the satellite may also be described by being replaced with terms such as a node, a hop, or a point existing on a routing path.

Meanwhile, the present invention will be described based on a low Earth orbit satellite network of a Walker-star constellation model. A satellite of the Walker-star constellation model moves along an orbit based on a given inclination, and a geometric plane including such an orbit is referred to as an orbit plane. All satellites of the low Earth orbit satellite network may have the same orbital altitude in each of a plurality of orbit planes, and satellites within the same orbit plane may be arranged at uniform intervals from one another. In addition, in order to avoid collision or interference at intersections of orbit planes, a phase difference exists between satellites in adjacent orbits.

The above-described low Earth orbit satellite network of the Walker-star constellation model is described for convenience of explanation, and the proposed distributed routing scheme may also be used in various other types of satellite networks different from the above-described low Earth orbit satellite network to distribute overload on inter-satellite links in high-density areas.

Hereinafter, the embodiments will be described in detail with reference to the accompanying drawings.

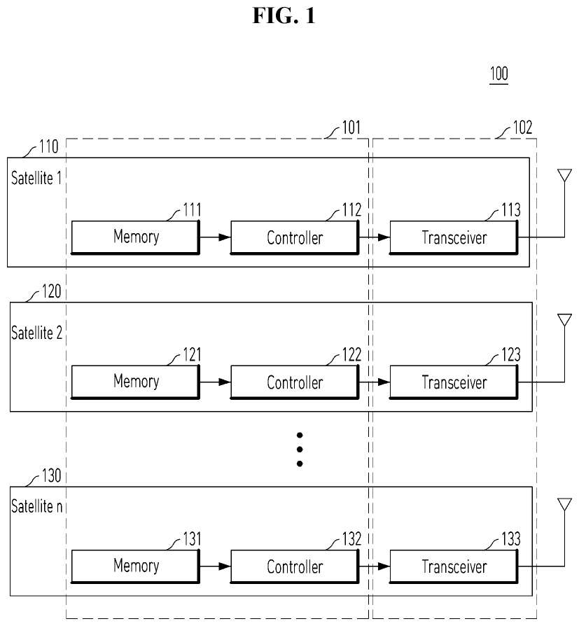

FIG. 1 is a block diagram illustrating a satellite system according to one embodiment.

Referring to FIG. 1, the satellite system may include a plurality of satellites 110, 120, and 130. Here, each of the satellites 110, 120, and 130 may establish a link for exchanging information with other neighboring satellites, and may communicate with base stations or terminals on the ground.

The first satellite 110 may include a memory 111, a controller 112, and a transceiver 113. The second satellite 120 may include a memory 121, a controller 122, and a transceiver 123. In addition, the n-th satellite may include a memory 131, a controller 132, and a transceiver 133.

As described above, since the first satellite 110 to the n-th satellite 130 have generally similar structures and functions, except that they are arranged and positioned at different altitudes within a predetermined orbital section over the Earth, the following description will be briefly made based on the first satellite 110.

Programs for operating the satellite, such as a driving program for causing the first satellite 110 to move along an orbit, may be stored in the memory 111, and data transmitted and received through transmission and reception of data packets may be temporarily stored therein.

The controller 112 may control overall operations of the satellite, and may control operations of the satellite using data stored in the memory 111 or may store data packets that are transmitted and received.

The transceiver 113 may be connected to an antenna and may transmit and receive data packets. The transceiver 113 may communicate with another satellite, a ground base station, a ground terminal, or the like by using the antenna.

The first satellite 110 may further include other components, such as a power supply unit (not shown), in addition to the above-described memory 111, controller 112, and transceiver 113.

Meanwhile, the satellite routing apparatus 100 proposed in the present invention may include a satellite router 101 and a satellite transceiver 102.

The satellite router 101 may perform routing of data packets transmitted and received between satellites. In this case, since the satellite router 101 routes data packets through each of the satellites located on a transmission path of the data packets, the satellite router 101 may be implemented through each of the plurality of satellites 110, 120, and 130, and in particular, may be implemented using the memories 111, 121, and 131 and/or the controllers 112, 122, and 132 included in the respective satellites.

The satellite router 101 may generate a routing table of a satellite by assigning a weight to an inter-satellite link (ISL) connecting satellites according to a traffic flow. In addition, the satellite router 101 may determine whether to detour a data packet by checking, using the generated routing table, a state of a buffer queue corresponding to a next-hop satellite to which the data packet is to be transmitted, and may transmit the data packet.

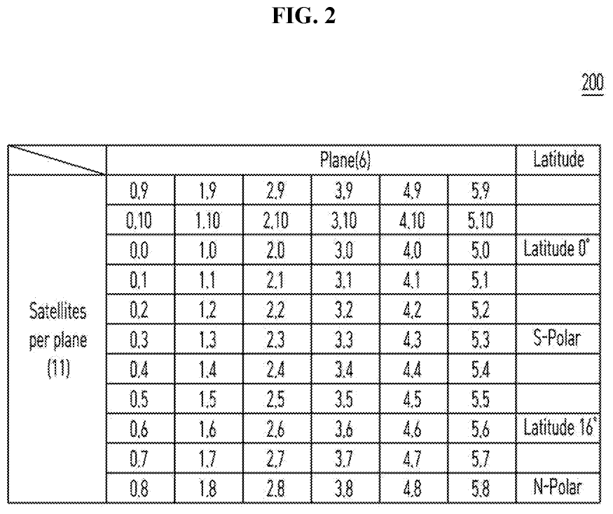

Detailed operations of the satellite router 101 will be described in detail below with reference to FIGS. 2 to 11.

The satellite transceiver 102 may transmit and receive data packets delivered from each of the satellites 110, 120, and 130 under the control of the satellite router 101.

Hereinafter, operations of the satellite router 101 will be described in detail with reference to FIGS. 2 to 5.

The satellite router 101 may generate a data packet. Data packet data may include information on a source satellite (SRC) and a destination satellite (DST), and may include information to be transmitted to another satellite, namely, data.

The satellite router 101 may represent a satellite constellation as a graph. In addition, the satellite router 101 may generate a network topology according to the satellite constellation.

FIG. 2 is a diagram illustrating generation of a network topology according to a satellite constellation according to one embodiment.

Referring to FIG. 2, a network topology 200 illustrates a satellite constellation in which 11 satellites are arranged in each of six planes. Each area indicated by coordinates (X, Y) represents a satellite, where X in the coordinates represents a plane number, and Y represents a satellite number. Each satellite on each plane is arranged with respect to a latitude disposed at the rightmost side of the network topology.

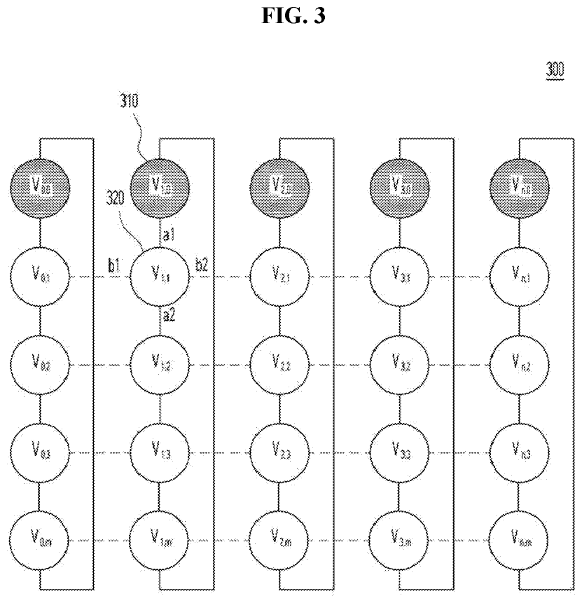

Thus, when a portion of the network topology 200 is connected using inter-satellite links (ISLs), it may be schematically illustrated as shown in FIG. 3.

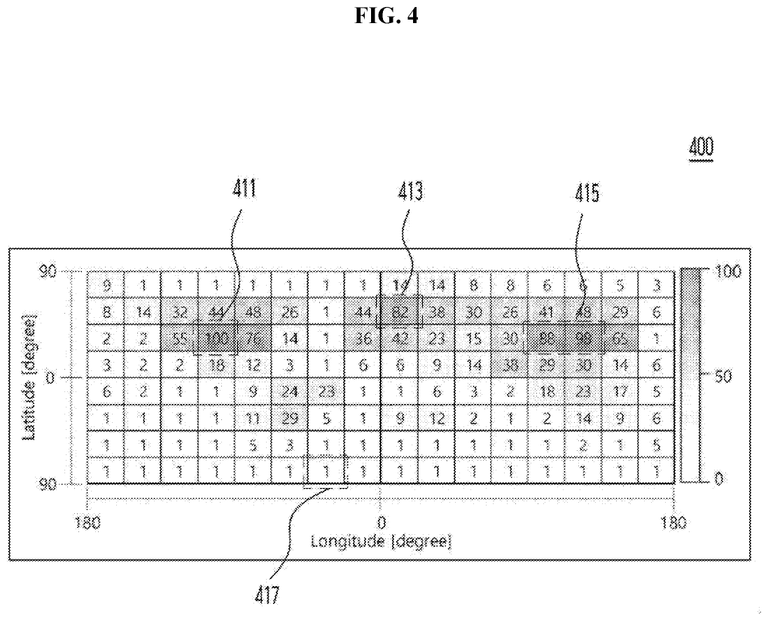

FIG. 3 is a diagram illustrating, as a network topology, a satellite constellation connected by inter-satellite links according to one embodiment. Referring to FIG. 4, a network topology 300 is a schematic illustration of a portion of the network topology 200 of FIG. 3. In the network topology 300, each satellite may correspond to a node, and each inter-satellite link (ISL) connecting the satellites may correspond to an edge. Here, the inter-satellite links (ISLs) may have directionality. In the network topology 300, the satellites are indicated by circles, and the edges are indicated by solid lines and dotted lines.

In the network topology 300, for satellites located in polar regions, it is difficult to establish inter-satellite links (ISLs) with satellites located in adjacent orbits because the antenna angle must be increased in order to establish the ISLs with the satellites located in the adjacent orbits. In addition, since satellites moving toward the North Pole or the South Pole have a relative speed difference that becomes very large compared to other satellites, there is a seam region in which inter-satellite links (ISLs) are not established with satellites located in adjacent orbits. That is, due to the seam region, it is difficult for satellites moving toward the North Pole or the South Pole to establish inter-satellite links with satellites located in adjacent orbits.

In the network topology 300, satellites indicated in a dark color and located in the uppermost row represent satellites located in polar regions. Referring to a first satellite 310 among the satellites located in the polar regions, the first satellite 310 may have two same-orbit inter-satellite links (ISLs) indicated by solid lines. Meanwhile, satellites located in a seam region may have two same-orbit inter-satellite links (ISLs) and one adjacent-orbit inter-satellite link (ISL).

In the network topology 300, most of the remaining satellites, excluding satellites located in the polar regions or the seam region, may have two same-orbit inter-satellite links (ISLs) and two adjacent-orbit inter-satellite links (ISLs), thereby forming a total of four inter-satellite links (ISLs).

For example, referring to the second satellite 320 in the network topology 300, the second satellite 320 may have two same-orbit inter-satellite links (ISLs) a1 and a2 indicated by solid lines, and may have two adjacent-orbit inter-satellite links (ISLs) b1 and b2 indicated by dotted lines, thereby forming four inter-satellite links (ISLs).

Accordingly, a satellite directly communicates with neighboring satellites using inter-satellite links (ISLs). Since the satellite moves along an orbit at a constant altitude, a distance between neighboring satellites is determined by latitude. A propagation delay occurs during communication according to the distance between the satellites.

Meanwhile, the satellite router 101 determines an optimal neighboring satellite for transmitting a data packet to a destination satellite (DST) according to a routing method in each of the satellites. The satellite router 101 may have a predetermined number of buffer queues, for example, four buffer queues, in which data packets to be transmitted to respective neighboring satellites wait. The satellite router 101 may cause a packet inserted into a buffer queue to wait in the buffer queue according to a processing rate of an inter-satellite link (ISL), and queueing delay may occur due to such waiting time. If the size of data stored in the buffer queue reaches the maximum size of the buffer queue, a data packet subsequently inserted into the buffer queue may be lost. Accordingly, based on a data packet, a sum of propagation delay and queueing delay from a time at which transmission starts from a source satellite (SRC) to a time at which the data packet arrives at a destination satellite (DST) may be defined as end-to-end delay (E2E delay).

Accordingly, the satellite router 101 uses global traffic distribution density in order to minimize end-to-end delay (E2E delay) and loss of data packets in a low Earth orbit satellite network. In addition, the satellite router 101 may generate a routing table by predicting a traffic flow based on the traffic distribution density, and may then select a detour route through which a data packet can be transmitted by reducing load on a routing path using the generated routing table.

The decision code based on a traffic-distribution-based routing table design operation in the satellite router 101 may be represented as shown in Table 1 below.

TABLE 1
Algorithm 1 Traffic distribution based graph generation

```
Input: G(V, E, W)
Output: RoutingTable in V
  1: for n = 1 to γ do
  2:  Run Dijkstra(G)
  3:  for (v_{src}, v_{dst}) in V, where v_{src} ≠ v_{dst} do
  4:  Get shortest path's weights W_{src,dst} ⊂ W
  5:  Calculate w_{q}(src, dst) by Equation (15)
  6:  for w in W_{src,dst} do
  7:  w = w + w_{q}(src, dst)
  8:  W ← w
  9:  end for
10:  end for
11: end for
12: for v_{src} in V do
13:  Run Dijkstra(G)
14:  for v_{dst} in V, where dst ≠ src do
15:  Get best next hop vbh in Vₚₐₜₕ^{G} (v_{src}, v_{dst})
16:  Generate a G' by removing Vₚₐₜₕ^{G} (v_{src}, v_{dst}) from the
      graph G
17:  Run Dijkstra(G )
18:  Get second-best next hop vsbh in Vₚₐₜₕ^{G′} (v_{src}, v_{dst})
19:  v_{src} · Routing Table[v_{dst}] · BestHop = v_{bh}
20:  v_{src} · Routing Table[v_{dst}] · SecondBestHop = v_{sbh}
21:  end for
22: end for = 0
```

The satellite router 101 may generate a topology graph G (V, E, W) of a satellite network, in which each satellite is represented as a node V, each inter-satellite link (ISL) is represented as an edge E, and each edge E includes a weight W applied thereto. Here, an initial weight is set by applying a propagation delay value according to a length of the inter-satellite link (ISL).

The satellite router 101 may search for a transmission path of a data packet using Dijkstra's shortest path algorithm. Dijkstra's shortest path algorithm is an algorithm for searching for a path in which weight values of edges between nodes are minimized. Accordingly, when the satellite router 101 applies Dijkstra's shortest path algorithm to the topology graph, transmission delay of the data packet may be minimized.

The satellite router 101 uses propagation delay as an initial value of the weight W in the topology graph. For example, the satellite router 101 may calculate a propagation delay between a first satellite v and a second satellite v′ using Equation 1 below.

$${d}_{prop} ( {υ}_{n}^{p} , {υ}_{{n}^{′}}^{{p}^{′}} ) = \{ \begin{matrix}\frac{{L}_{intra} ( {υ}_{n}^{p} , {υ}_{{n}^{′}}^{{p}^{′}} )}{c} & if p = {p}^{′} \\ \frac{{L}_{intra} ( {υ}_{n}^{p} , {υ}_{{n}^{′}}^{{p}^{′}} )}{c} & if n = {n}^{′}\end{matrix} , \qquad [ Equation 1 ]$$

Here, Lintra denotes a distance between same-orbit satellites, and Linter denotes a distance between adjacent-orbit satellites. In this case, the satellite router 101 may calculate the distance between the same-orbit satellites using Equation 2 below, and may calculate the distance between the adjacent-orbit satellites using Equation 3 below.

$${L}_{intra} ( {υ}_{n}^{p} , {υ}_{n + 1}^{p} ) = \sqrt{2} R \sqrt{1 - cos ( \frac{2 π}{{N}_{npo}} )} , \qquad [ Equation 2 ]$$

$${L}_{intra} ( {υ}_{n}^{{p}_{i}} , {υ}_{n}^{{p}_{i + 1}} ) = \sqrt{2} {R ( 1 - cos ϕ + ( 1 - cos ψ ) \times cos ( lat ( {υ}_{n}^{{p}_{i}} ) ) cos ( lat ( {υ}_{n}^{{p}_{i + 1}} ) ) )}^{\frac{1}{2}} \qquad [ Equation 3 ]$$

Here, Nnpo denotes the number of satellites included in one orbit plane, φ denotes a phase difference between adjacent satellites, denotes a latitude ψ difference between two satellites, and lat(v) denotes the current latitude of satellite v.

Lintra always maintains a constant value when satellites are uniformly arranged within a predetermined satellite model. In contrast, Linter varies depending on the current latitude of the satellite. Linter of a satellite located at a high latitude has a smaller value than that of a satellite located at a low latitude. Accordingly, in a shortest-distance-based routing technique, since propagation delay between high-latitude satellites is short, high-latitude regions are preferred for traffic delivery between adjacent orbits.

Thereafter, the satellite router 101 may predict a traffic flow in order to reflect a weight for queueing delay.

FIG. 4 is a diagram illustrating traffic distribution density values of surface areas according to one embodiment.

Referring to FIG. 4, the surface of the Earth is divided into unit areas of 8×16, and a traffic distribution density value is recorded in each unit area. Such traffic distribution density values may be calculated based on, for example, the number of Internet users and the population.

Referring to the traffic distribution density, in unit areas 411, 413, and 415, a large amount of traffic may be distributed because the traffic distribution density values are relatively higher than those of other areas. In contrast, in unit area 417, a small amount of traffic may be distributed because the traffic distribution density value is relatively lower than those of other areas. That is, a higher numerical value of the traffic distribution density indicates that the traffic distribution is more congested.

The satellite router 101 may predict a traffic flow based on the traffic distribution density, and may calculate a weight for queueing delay of each inter-satellite link (ISL). The satellite router 101 may calculate a weight ω_{q}(src, dst) of predicted queueing delay for a data packet, that is, traffic, transmitted from a source satellite (SRC) at which traffic is generated to a destination satellite (DST), using Equation 4 below.

$${w}_{q} ( src , dst ) = \frac{{D}_{src}}{{D}_{max}} \times \frac{{D}_{dst}}{{\sum }_{x ∈ D , x \neq src}^{N} {D}_{x}} , \qquad [ Equation 4 ]$$

Here, Dx denotes a density value of area x in the traffic distribution density. Next, in order to reflect the weight, the satellite router 101 finds, in the topology graph, a path having a minimum sum of weights from the source satellite (SRC) to the destination satellite (DST) using Dijkstra's shortest path algorithm. The satellite router 101 may update the weights by adding the calculated ω_{q}(src, dst) to the existing weight W of each of all inter-satellite links (ISLs) included in the found path, that is, each corresponding edge in the topology graph.

The satellite router 101 performs weighting of the topology graph based on pairs of source satellites (SRCs) and destination satellites (DSTs) for all satellites. Accordingly, an inter-satellite link (ISL) that is frequently used due to a large traffic flow has a higher weight than an inter-satellite link (ISL) that is infrequently used due to a small traffic flow. Through this, the satellite router 101 may distribute routing paths by reflecting the traffic flow in the weights of the topology graph. However, in an area where traffic distribution is concentrated, the routing path may continue to use the same path.

Accordingly, the satellite router 101 reflects an iterative predicted queueing delay weight for distributing routing paths in a concentrated area. For example, the satellite router 101 may re-search for a path having a minimum sum of weights in the topology graph in which the weights have been changed, and may add the weight ω_{q}(src, dst) of the predicted queueing delay. The satellite router 101 may repeat such a weight reflection operation to increase the weights of inter-satellite links (ISLs) in a high-density traffic distribution area, thereby inducing avoidance of overlap between routing paths. That is, the satellite router 101 may reduce situations in which routing paths overlap, thereby preventing overload of data queues provided for transmitting data packets through respective inter-satellite links (ISLs).

The satellite router 101 may update the weights in the topology graph so as to prevent overload on routing paths, and may generate a routing table of each satellite using the topology graph in which the weights have been updated. Here, the routing table may store information on a best next-hop satellite (BH) and a second-best next-hop satellite (SBH) for a destination satellite (DST).

The decision code based on a load-distribution routing operation in the satellite router 101 may be represented as shown in Table 2 below.

TABLE 2
Algorithm 2 Load balancing routing algorithm

```
Input: Current satellite v_{c}, Packet pkt, Qₒ^{v}'s threshold ϵ
Output: nextHop
  1: v_{dst} = pkt · dst
  2: v_{bh} = v_{c} · RoutingTable[v_{dst}] · BestHop
  3: v_{sbh} = v_{c} · RoutingTable[v_{dst}] · SecondBestHop
  4: Calculate Qₒ^{v} (v_{bh}, t) by equation (16)
  5: If Qₐ (BH) ≤ ϵ then
  6:  nextHop = v_{bh}
  7: else
  8:  v_{dst} = pkt · dst
  9:  Calculate Qₐ^{v} (v_{sbh}, t) by equation (16)
10:  if v_{dst} = v_{bh} then
11:  nextHop = v_{bh}
12:  else if Qₐ^{v}(v_{sbh}, t) > ϵ then
13:  nextHop = v_{bh}
14:  else if vₚᵣₑᵥ = v_{sbh} then
15:  nextHop = v_{bh}
16:  else
17:  nextHop = v_{sbh}
18:  end if
19: end if = 0
```

The satellite router 101 may identify information on a best next-hop satellite (BH) and a second-best next-hop satellite (SBH) from the routing table, and may determine whether the second-best next-hop satellite (SBH) is to be used as a detour route for load distribution.

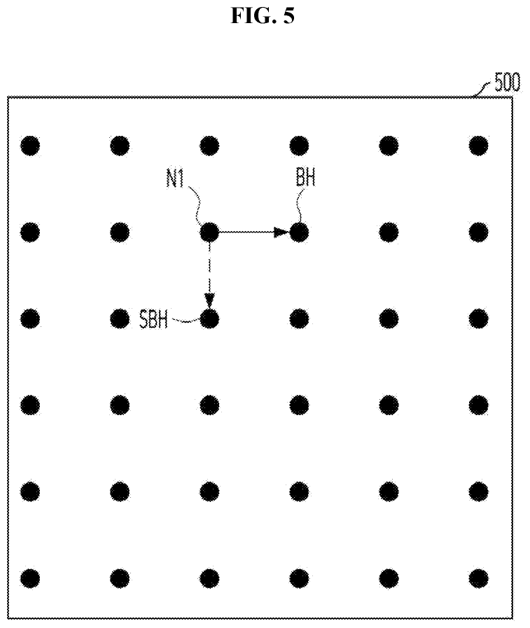

FIG. 5 is a diagram illustrating selection of a best next-hop satellite and a second-best next-hop satellite according to one embodiment.

Referring to FIG. 5, based on the satellite constellation, a satellite N1 may select one of a best next-hop satellite (BH) and a second-best next-hop satellite (SBH), and may transmit a data packet thereto. The best next-hop satellite (BH) may be a satellite having the best state of an inter-satellite link (ISL) for transmitting the data packet around the satellite N1, and the second-best next-hop satellite (SBH) may be a satellite having the best state among inter-satellite links (ISLs) with remaining hop satellites other than the best next-hop satellite (BH). Accordingly, when overload occurs in transmission of the data packet to the best next-hop satellite (BH), the routing path may be detoured using the second-best next-hop satellite (SBH).

In a conventional satellite network, a next-hop satellite is selected by periodically performing an operation of collecting buffer queue states of neighboring satellites or all satellites, but this requires periodic exchange of information between satellites. When overload for transmitting data packets occurs on a link, if signals used for modifying a routing table or distributing load, rather than data packets, increase, network resources for transmitting actual data packets, for example, inter-satellite links (ISLs), buffer queues, and the like, are consumed.

Meanwhile, even when routing paths are distributed, if the amount of traffic increases, overload may occur on an inter-satellite link (ISL). Accordingly, the satellite router 101 performs load-distribution routing in which packets are detoured according to a queue state of a buffer.

As described above, the satellite router 101 may check a current size of a buffer queue in each direction of the satellite for transmission of a data packet, without exchanging information between satellites, and may determine a next-hop satellite according to an occupancy rate of the buffer queue.

The satellite router 101 may calculate, at time t, a size of a buffer queue of satellite v in a direction of v′ using Equation 5 below.

$${Q}_{v}^{{v}^{′}} ( t ) = {Q}_{v}^{{v}^{′}} ( t - 1 ) + {T}_{v}^{En , {v}^{′}} ( t ) - min ( {Q}_{v}^{{v}^{′}} ( t - 1 ) , {C}_{ISL} ) \qquad [ Equation 5 ]$$

Here, the corresponding variable

$${T}_{v}^{En , {v}^{′}} ( t )$$

denotes an amount of packets, among packets received by satellite v at time t, whose next hop is v′.

In addition, the satellite router 101 may calculate an occupancy rate of the buffer queue using Equation 6 below.

$${Q}_{o}^{v} ( {v}^{′} , t ) = \frac{{Q}_{v}^{{v}^{′}} ( t )}{{Q}_{max}} , \qquad [ Equation 6 ]$$

$$s . t . {v}^{′} ∈ {V}_{adj} ( v ) .$$

Here, the corresponding variable Qₘₐₓ denotes a maximum size of the buffer queue.

The satellite router 101 may detour and transmit the data packet to the second-best next-hop satellite (SBH) when an occupancy rate of a buffer queue of the best next-hop satellite (BH), which is denoted by the corresponding variable

$${Q}_{o}^{v} ( BH , t ) ,$$

is equal to or greater than a predetermined threshold.

A routing loop may occur in the satellite router 101 due to the detour route. In order to prevent this, the satellite router 101 applies detour prevention conditions according to transmission of the data packet. For example, when at least one of the following conditions is satisfied: the next-hop satellite (BH) is the destination; an occupancy rate of a buffer queue in a direction of the SBH is also equal to or greater than the predetermined threshold; and the SBH is a satellite on a previous path through which the data packet has been transmitted, the satellite router 101 may transmit the data packet to the best next-hop satellite (BH) without detouring the data packet.

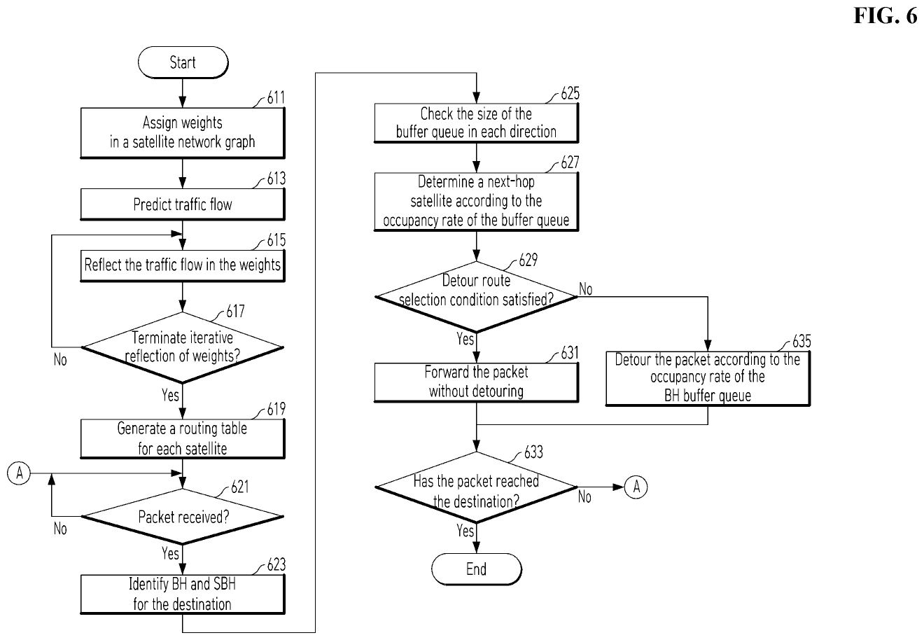

FIG. 6 is a flowchart illustrating a distributed routing operation in a routing apparatus according to one embodiment.

Referring to FIG. 6, the satellite routing apparatus 100 assigns a weight to each inter-satellite link (ISL) in order to generate a topology graph of a satellite network (step 611). The satellite routing apparatus 100 may generate a topology graph G (V, E, W) including nodes V corresponding to satellites, edges E corresponding to inter-satellite links (ISLs), and weights W for the inter-satellite links (ISLs). The satellite routing apparatus 100 may set propagation delay between satellites as an initial value of the weight in the topology graph.

The satellite routing apparatus 100 may predict a traffic flow to be transmitted through the satellite network (step 613). Here, the traffic flow may be calculated using traffic distribution density for each of unit areas obtained by dividing the surface of the Earth, and the traffic distribution density may be calculated based on the number of Internet users and the population within each unit area.

The satellite routing apparatus 100 may reflect the predicted traffic flow in the weights in the topology graph (step 615). The satellite routing apparatus 100 may use a gravity model in order to reflect weights in the inter-satellite links (ISLs). Here, the gravity model is a model used to predict a flow between two points, and predicts a traffic flow between the two points using a traffic distribution density index.

In addition, the satellite routing apparatus 100 may update, in the topology graph, a weight for each inter-satellite link (ISL) to a queueing delay time of the inter-satellite link calculated based on the traffic flow, that is, a predicted queueing delay time.

The satellite routing apparatus 100 determines whether to iteratively reflect the weight (step 617). As a result of the determination in step 617, when the satellite routing apparatus 100 intends to iteratively reflect the weight, the process may proceed to step S615, and the satellite routing apparatus 100 may repeatedly update the weight based on the calculated queueing delay by repeatedly searching, a predetermined number of times or more, for a shortest path having a minimum weight.

As a result of the determination in step 617, when the satellite routing apparatus 100 terminates iterative reflection of the weight, the process proceeds to step S619.

The satellite routing apparatus 100 may generate a routing table for each satellite (step 619).

The satellite routing apparatus 100 checks whether a data packet has been received (step 621).

As a result of the checking in step 621, when the satellite routing apparatus 100 has not received a data packet, the satellite routing apparatus 100 waits until a data packet is received.

As a result of the checking in step 621, when the satellite routing apparatus 100 receives the data packet, the process proceeds to step S623. The satellite routing apparatus 100 identifies, using the routing table, a best next-hop satellite (BH) and a second-best next-hop satellite (SBH) for a destination satellite of the received data packet (step 625).

The satellite routing apparatus 100 may check a size of a buffer queue for each direction of the satellite (step 627). That is, the satellite routing apparatus 100 may check a usage amount of the buffer queue for each direction of the satellite, namely, an occupancy state of data packets.

The satellite routing apparatus 100 determines a next-hop satellite according to a current occupancy rate of the buffer queue (step 629).

At this time, when transmitting the data packet, the satellite routing apparatus 100 may determine whether the data packet corresponds to a detour route selection condition (step 629).

As a result of the determination in step 629, when the satellite routing apparatus 100 corresponds to the detour route selection condition, the process proceeds to step 631. When the satellite routing apparatus 100 corresponds to the detour route selection condition, the satellite routing apparatus 100 forwards the data packet without detouring the data packet (step 631).

Here, the detour route selection conditions are as follows. First, the best next-hop satellite (BH) is the destination. Second, an occupancy rate of a buffer queue in a direction of the second-best next-hop satellite (SBH) is equal to or greater than a predetermined threshold. Third, the SBH is a satellite on a previous path through which the data packet has been transmitted. Accordingly, when at least one of the above three conditions is satisfied, the satellite routing apparatus 100 may forward the packet without detouring the packet.

As a result of the determination in step 629, when the satellite routing apparatus 100 does not correspond to the detour route selection condition, the process proceeds to step 635. For a data packet that does not correspond to the detour route selection condition, the satellite routing apparatus 100 detours and transmits the data packet according to an occupancy rate of a buffer queue of the best next-hop satellite (BH).

In step 633, the satellite routing apparatus 100 checks whether the packet has reached the destination. In step 633, when the packet has reached the destination, the satellite routing apparatus 100 may terminate the process. However, in step 633, when the packet has not reached the destination, the satellite routing apparatus 100 proceeds to step 621 and performs an operation of receiving and processing a data packet.

As described above, conventionally, it has not been possible to distribute load on inter-satellite links (ISLs) caused by imbalanced traffic distribution. In imbalanced traffic distribution, traffic flow between some areas is large, and since packets corresponding to the traffic flow are delivered through the same routing path, overload occurs on a specific inter-satellite link (ISL). Overload on the inter-satellite link (ISL) increases end-to-end delay (E2E delay) of packets using the corresponding inter-satellite link (ISL) as a routing path, and causes packet loss when the amount of traffic increases. High end-to-end delay degrades user experience, such as service interruption and delayed response time, and packet loss causes packet retransmission, thereby further aggravating the overload problem of the inter-satellite link (ISL).

However, since the distributed routing technique proposed in the present invention generates a routing table reflecting traffic distribution, routing paths may be distributed by reflecting traffic flows. The distributed routing paths reduce occurrence of overload on inter-satellite links (ISLs) by minimizing overlap between routing paths of packets. In addition, by using a load-distribution routing algorithm, a routing path of a packet may be detoured according to a load of a buffer queue, thereby minimizing occurrence of overload on an ISL and reducing end-to-end delay and packet loss of the packet.

A simulation environment for evaluating performance of the technique proposed in the present invention will be briefly described. In the simulation environment, the number of LEO satellites is 128, and 16 satellites are arranged in each of 8 orbit planes. Each orbit plane has an orbital inclination of about 89°, and satellites within the orbit plane are arranged at uniform intervals at an altitude of about 800 km. Each satellite has about four buffer queues each having a size of 2.5 MB, and may store packets to be delivered to neighboring satellites. An inter-satellite link (ISL) processes packets in the buffer queues at a rate of 260 Mbps. In the simulation environment, routing performance for 1 minute (60,000 ms) is evaluated by increasing a packet generation rate from 6.0 Gbps to 11.5 Gbps in increments of 0.5 Gbps. Each packet has a size of 1 KB and is generated every 1 ms. A source and a destination of each packet are determined based on a gravity model according to traffic distribution density.

Two techniques are used to compare the performance of the present invention. First, the technique proposed in the present invention is indicated as “Proposed.” A first benchmark technique is an explicit load balancing scheme, which is indicated by the term “ELB” in the simulation graphs. In this technique, satellites explicitly exchange information on congestion states with neighboring satellites and route packets according to congestion levels. A second benchmark technique is a traffic-light-based load balancing scheme, which is indicated by the term “TLR” in the simulation graphs. In this technique, a traffic light color is determined according to a congestion state of a buffer queue in each direction and a congestion state of a neighboring satellite, and packets are routed according to the traffic light color. The two techniques used for comparison periodically collect information on congestion states of all satellites in the network and modify routing tables.

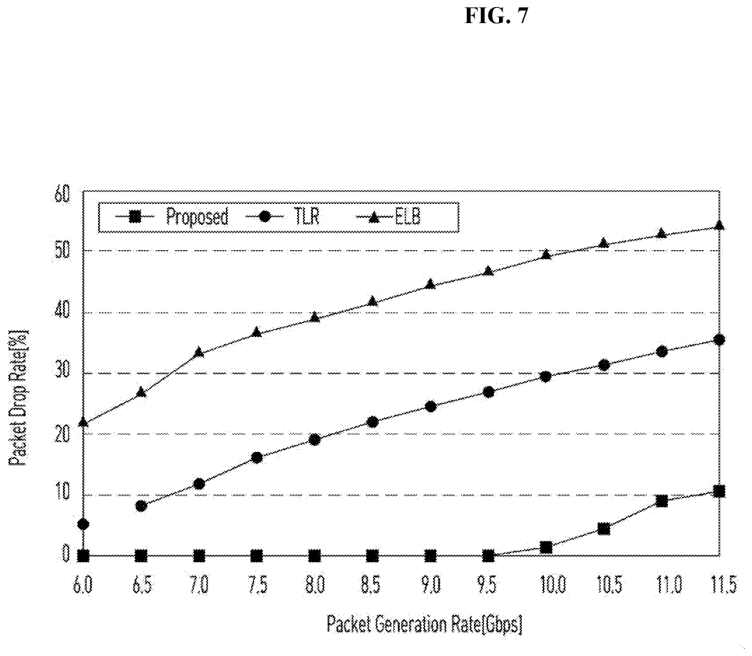

FIG. 7 is a graph illustrating an average packet loss rate of packets arriving at a destination while varying a packet generation rate according to one embodiment.

Referring to FIG. 7, the horizontal axis of the graph represents a packet generation rate, and the vertical axis represents a packet loss rate. Here, packet loss considers only a case in which a packet is lost due to a drop-tail buffer queue. The packet loss rate is a ratio of the number of lost packets to the total number of generated packets. As a result of comparing the proposed embodiment with the comparison target techniques, that is, the TLR technique and the ELB technique, while increasing the packet generation rate, it can be confirmed that the number of lost packets is close to zero (0) until a certain number of packets are generated, and that the packet loss rate is significantly lower than those of the comparison target techniques.

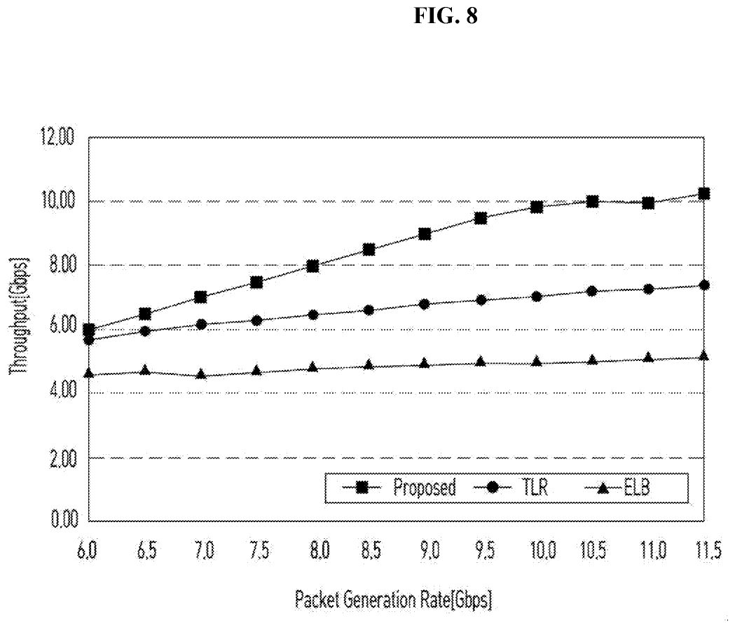

FIG. 8 is a graph illustrating throughput of packet data while varying a packet generation rate according to one embodiment.

Referring to FIG. 8, the horizontal axis of the graph represents a packet generation rate, and the vertical axis represents throughput. Here, the packet throughput represents the number of data packets that have reached the destination among the total number of generated data packets. As a result of comparing the proposed embodiment with the comparison target techniques, that is, the TLR technique and the ELB technique, while increasing the packet generation rate, it can be confirmed that the throughput of data packets is relatively high.

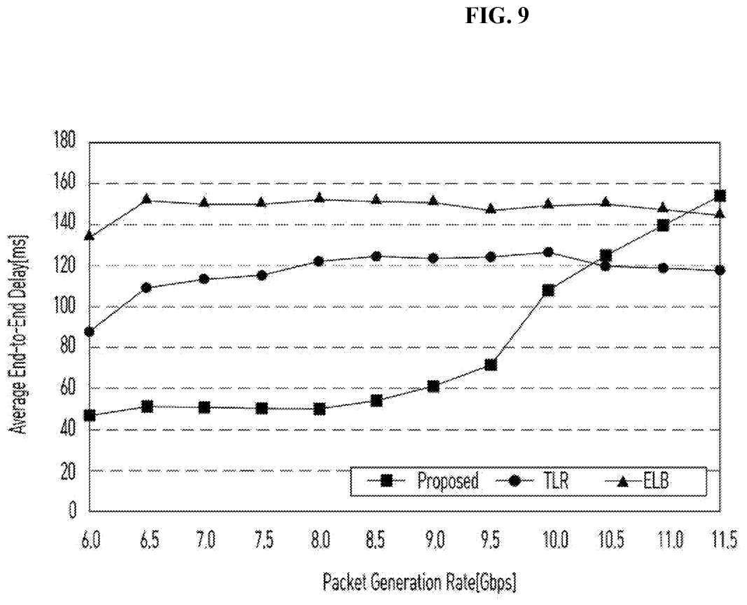

FIG. 9 is a graph illustrating an average end-to-end delay of packets while varying a packet generation rate according to one embodiment.

Referring to FIG. 9, the horizontal axis of the graph represents a packet generation rate, and the vertical axis represents an average end-to-end delay. Here, the average end-to-end delay refers to an arrival time from a source satellite to a destination satellite. As a result of comparing the proposed embodiment with the comparison target techniques, that is, the TLR technique and the ELB technique, while increasing the packet generation rate, it can be confirmed that the average end-to-end delay remains significantly short until the generation rate of data packets exceeds 10.5 Gbps.

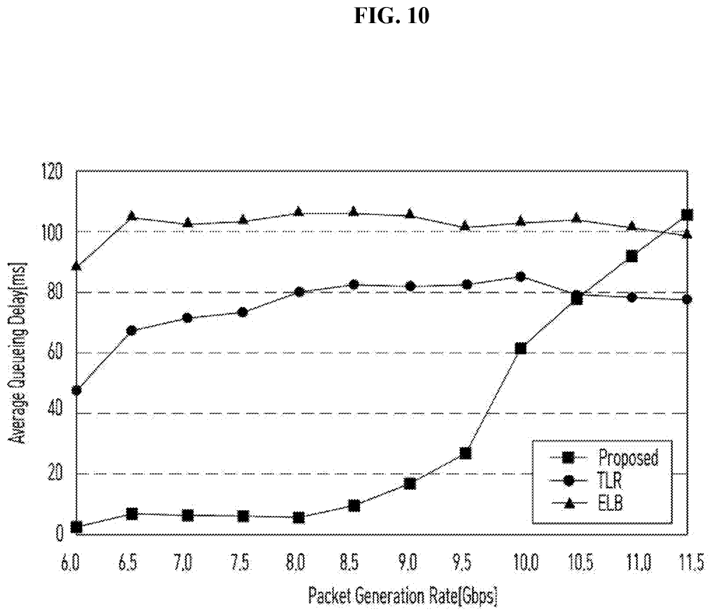

FIG. 10 is a graph illustrating an average queueing delay of packets arriving at a destination while varying a packet generation rate according to one embodiment.

Referring to FIG. 10, the horizontal axis of the graph represents a packet generation rate, and the vertical axis represents an average queueing delay. Here, the average queueing delay refers to a sum of queueing delay times occurring in a routing path of a packet. As a result of comparing the proposed embodiment with the comparison target techniques, that is, the TLR technique and the ELB technique, while increasing the packet generation rate, it can be confirmed that the average queueing delay remains significantly short until the generation rate of data packets exceeds 10.5 Gbps.

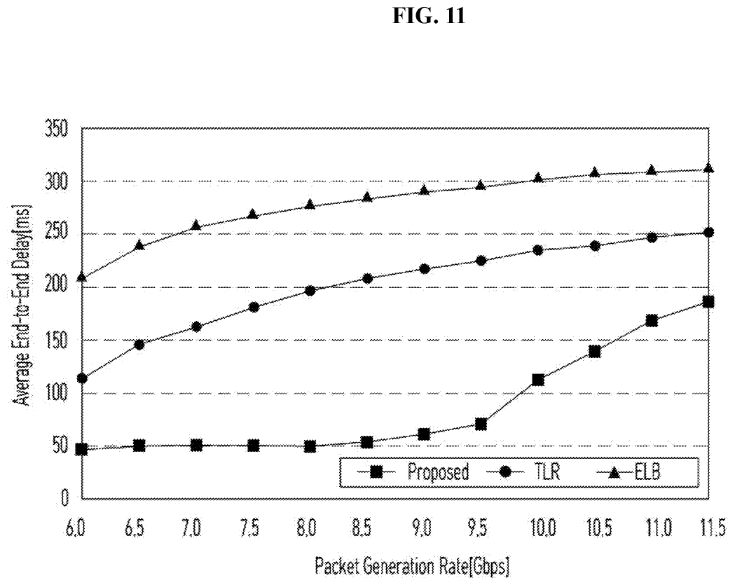

FIG. 11 is a graph illustrating an average end-to-end delay of all packets while varying a packet generation rate according to one embodiment.

Referring to FIG. 11, the horizontal axis of the graph represents a packet generation rate, and the vertical axis represents an average end-to-end delay of all packets. Here, in order to compare end-to-end delay by reflecting packet loss, end-to-end delay of a lost packet is regarded as having a maximum queueing delay in a shortest-distance routing path. As a result of comparing the proposed embodiment with the comparison target techniques, that is, the TLR technique and the ELB technique, while increasing the packet generation rate, it can be confirmed that the average end-to-end delay is significantly short.

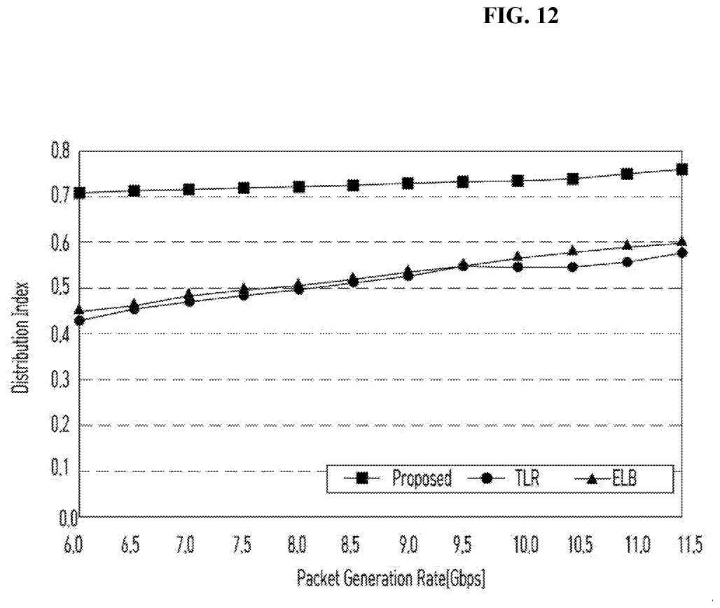

FIG. 12 is a graph illustrating a distribution index while varying a packet generation rate according to one embodiment.

Referring to FIG. 12, the horizontal axis of the graph represents a packet generation rate, and the vertical axis represents a distribution index (DI). Utilization of inter-satellite links (ISLs) may be calculated as the distribution index (DI), and may be calculated using Equation 7 below.

$$DI = \frac{{( {\sum }_{\text{?}}^{\text{?}} {x}_{\text{?}} )}^{2}}{{N}_{\text{?}} \times {\sum }_{\text{?}}^{\text{?}} {( {x}_{\text{?}} )}^{2}} \qquad [ Equation 7 ]$$

$$\text{?} \text{indicates text missing or illegible when filed}$$

Here, when the total number of inter-satellite links (ISLs) is NIsz and the number of uses of a k-th inter-satellite link (ISL) is xk, the distribution index (DI) may have a value between 0 and 1. When the numbers of uses of the inter-satellite links (ISLs) are all the same, the distribution index (DI) is 1, and when only a specific inter-satellite link (ISL) is mainly used, the distribution index (DI) decreases.

As a result of comparing the proposed embodiment with the comparison target techniques, that is, the TLR technique and the ELB technique, while increasing the packet generation rate, it can be confirmed that the distribution index (DI) is high.

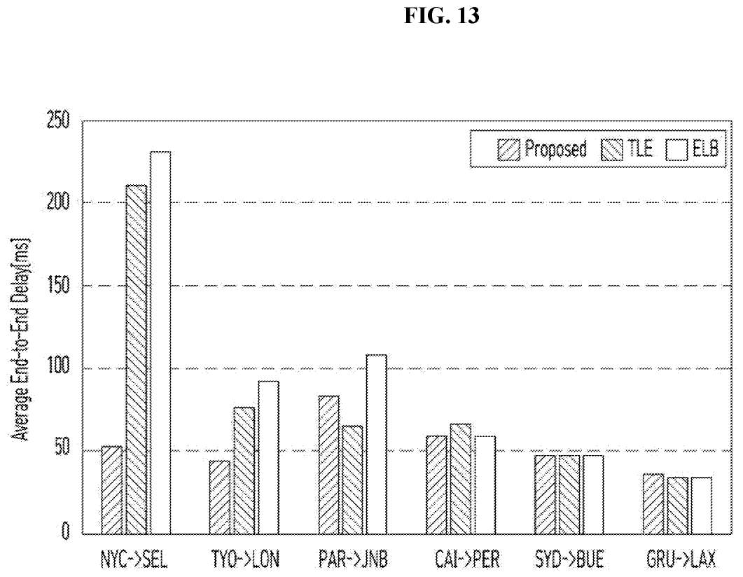

Referring to FIG. 13, the horizontal axis of the graph represents major cities on continents between which packets are delivered end-to-end, and the vertical axis represents an average end-to-end delay. The graph compares average end-to-end delays of packets delivered between two regions according to three routing schemes by selecting major cities on each continent. The representative packet flows between major cities include New York (NYC)→Seoul (SEL), Tokyo (TYO)→London (LON), Paris (PAR)→Johannesburg (JNB), Cairo (CAI)→Perth (PER), Sydney (SYD)→Buenos Aires (BUE), and São Paulo (GRU)→Los Angeles (LAX).

As a result of comparing the proposed embodiment with the comparison target techniques, that is, the TLR technique and the ELB technique, in terms of average end-to-end delay according to transmission of data packets between major cities, it can be confirmed that the proposed embodiment provides superior performance in some cases and is not significantly degraded compared to the comparison target techniques in the remaining cases.

The term “unit” used in the above embodiments refers to a software component or a hardware component, such as a field programmable gate array (FPGA) or an application specific integrated circuit (ASIC), and the “unit” performs certain roles. However, the “unit” is not limited to software or hardware. The “unit” may be configured to be in an addressable storage medium, or may be configured to execute one or more processors. Accordingly, as an example, the “unit” includes components such as software components, object-oriented software components, class components, and task components, as well as processes, functions, attributes, procedures, subroutines, segments of program code, drivers, firmware, microcode, circuits, data, databases, data structures, tables, arrays, and variables.

Functions provided in the components and the “units” may be combined into a smaller number of components and “units,” or may be separated into additional components and “units.”

In addition, the components and the “units” may be implemented to execute one or more CPUs in a device or a secure multimedia card.

The above-described embodiments are provided for illustrative purposes, and those skilled in the art to which the above-described embodiments pertain will understand that the above-described embodiments may be easily modified into other specific forms without changing the technical spirit or essential features thereof. Therefore, the above-described embodiments should be understood as being illustrative in all respects and not restrictive. For example, each component described in a singular form may be implemented in a distributed form, and likewise, components described as being distributed may be implemented in a combined form.

The scope sought to be protected through the present disclosure is defined by the claims described below rather than by the detailed description above, and should be construed as including all changes or modifications derived from the meaning and scope of the claims and equivalents thereof.

What is claimed is:

1. A satellite routing apparatus comprising:
a satellite transceiver configured to transmit and receive a data packet; and
a satellite router configured to determine a next satellite to which the data packet is to be transmitted and to transmit the data packet,
wherein the satellite router is configured to generate a routing table of a satellite by assigning a weight to an inter-satellite link according to a predicted traffic flow, and to determine whether to detour the data packet by checking a state of a buffer queue in a next-hop direction to which the data packet is to be transmitted using the routing table.

2. The satellite routing apparatus of claim 1,
wherein the satellite router is configured to generate a topology graph of a satellite network in which a satellite is formed as a node and an inter-satellite link (ISL) is formed as an edge,
wherein the edge in the topology graph has a weight, and the weight is set to an inter-satellite propagation delay time as an initial value.

3. The satellite routing apparatus of claim 2,
wherein the satellite router is configured:
to use a gravity model for predicting a traffic flow between two points using an index of traffic distribution density divided into a plurality of unit areas, and
to update, in the topology graph, a weight for each inter-satellite link by determining a weight ω_{q}(src, dst) of queueing delay time of the inter-satellite link calculated based on the traffic flow using the following equation:
$${w}_{q} ( src , dst ) = \frac{{D}_{src}}{{D}_{max}} \times \frac{{D}_{dst}}{{\sum }_{x ∈ D , x \neq src}^{N} {D}_{x}} ,$$
wherein Dx denotes a density value of an area x in the traffic distribution density.

4. The satellite routing apparatus of claim 3,
wherein the satellite router is configured to generate a routing table of each satellite using the topology graph in which the weight has been updated based on calculated queueing delay by repeatedly searching, a predetermined number of times or more, for a shortest path having a minimum weight,
wherein the searching for the shortest path uses Dijkstra's shortest path algorithm to search for a path having a minimum sum of weights from a source satellite (SRC) to a destination satellite (DST).

5. The satellite routing apparatus of claim 1,
wherein the satellite router is configured to:
identify a best next-hop satellite (BH) and a second-best next-hop satellite (SBH) from the routing table of the satellite; and
determine a next satellite to which a next data packet is to be transmitted according to an occupancy rate of a buffer queue.

6. The satellite routing apparatus of claim 5,
wherein the satellite router is configured to:
calculate a size of the buffer queue using the following equation:
$${Q}_{v}^{{v}^{′}} ( t ) = {Q}_{v}^{{v}^{′}} ( t - 1 ) + {T}_{v}^{En , {v}^{′}} ( t ) - min ( {Q}_{v}^{{v}^{′}} ( t - 1 ) , {C}_{ISL} )$$
wherein the corresponding variable
$${T}_{v}^{En , {v}^{′}} ( t )$$
denotes an amount of packets, among packets received by satellite v at time t, whose next hop is v′, and
calculate an occupancy rate of the buffer queue using the following equation:
$${Q}_{o}^{v} ( {v}^{′} , t ) = \frac{{Q}_{v}^{{v}^{′}} ( t )}{{Q}_{max}} ,$$
$$s . t . {v}^{′} ∈ {V}_{adj} ( v ) .$$
wherein the corresponding variable Qₘₐₓ denotes a maximum size of the buffer queue.

7. The satellite routing apparatus of claim 6,
wherein the satellite router is configured to detour and transmit the data packet to the second-best next-hop satellite (SBH) when an occupancy rate of a buffer queue
$${Q}_{o}^{v} ( BH , t )$$
of the best next-hop satellite (BH) is equal to or greater than a predetermined threshold.

8. The satellite routing apparatus of claim 5,
wherein the satellite router is configured to:
transmit, without detouring, a data packet corresponding to a detour route selection condition; and
detour and transmit a data packet not corresponding to the detour route selection condition according to an occupancy rate of a buffer queue of the best next-hop satellite (BH),
wherein the detour route selection condition includes at least one of: a case in which the best next-hop satellite (BH) is a destination; a case in which an occupancy rate of a buffer queue in a direction of the second-best next-hop satellite (SBH) is equal to or greater than a predetermined threshold; and a case in which the second-best next-hop satellite (SBH) is a satellite on a previous path through which the data packet has been transmitted.

9. A distributed routing method of a satellite routing apparatus, the distributed routing method comprising:
generating a topology graph of a satellite network;
predicting a traffic flow to be transmitted through the satellite network;
updating, in the topology graph, a weight for each inter-satellite link to a queueing delay time of the inter-satellite link calculated based on the traffic flow;
generating a routing table of each satellite;
when a data packet is received, identifying a best next-hop satellite (BH) and a second-best next-hop satellite (SBH) for a destination satellite; and
determining a next satellite to which the data packet is to be transmitted by checking an occupancy rate of a buffer queue, and transmitting the data packet.

10. The distributed routing method of claim 9,
wherein generating the topology graph further comprises:
setting a weight in the topology graph to a propagation delay time between adjacent satellites as an initial value.

11. The distributed routing method of claim 9,
wherein updating to the queueing delay time comprises:
determining and updating a weight ω_{q}(src, dst) of queueing delay time of the inter-satellite link calculated based on the traffic flow using the following equation:
$${w}_{q} ( src , dst ) = \frac{{D}_{src}}{{D}_{max}} \times \frac{{D}_{dst}}{{\sum }_{x ∈ D , x \neq src}^{N} {D}_{x}} ,$$
wherein Dₓ denotes a density value of an area x in a traffic distribution density.

12. The distributed routing method of claim 9,
wherein updating to the queueing delay time further comprises:
updating the weight based on calculated queueing delay by repeatedly searching, a predetermined number of times or more, for a shortest path having a minimum weight,
wherein the searching for the shortest path uses Dijkstra's shortest path algorithm.

13. The distributed routing method of claim 9,
wherein predicting the traffic flow further comprises:
using a gravity model for predicting a traffic flow between two points using an index of traffic distribution density divided into a plurality of unit areas,
wherein the index of the traffic distribution density includes a number of Internet users and a population of each unit area.

14. The distributed routing method of claim 9,
wherein transmitting the data packet comprises:
calculating a size of the buffer queue using the following equation:
$${Q}_{v}^{{v}^{′}} ( t ) = {Q}_{v}^{{v}^{′}} ( t - 1 ) + {T}_{v}^{En , {v}^{′}} ( t ) - min ( {Q}_{v}^{{v}^{′}} ( t - 1 ) , {C}_{ISL} )$$
wherein the corresponding variable
$${T}_{v}^{En , {v}^{′}} ( t )$$
denotes an amount of packets, among packets received by satellite v at time t, whose next hop is v′, and
calculating an occupancy rate of the buffer queue using the following equation:
$${Q}_{o}^{v} ( {v}^{′} , t ) = \frac{{Q}_{v}^{{v}^{′}} ( t )}{{Q}_{max}} ,$$
$$s . t . {v}^{′} ∈ {V}_{adj} ( v ) .$$
wherein the corresponding variable Qₘₐₓ denotes a maximum size of the buffer queue.

15. The distributed routing method of claim 9,
wherein transmitting the data packet comprises:
transmitting, without detouring, a data packet corresponding to a detour route selection condition; and
detouring and transmitting a data packet not corresponding to the detour route selection condition according to an occupancy rate of a buffer queue of the best next-hop satellite (BH),
wherein the detour route selection condition includes at least one of: a case in which the best next-hop satellite (BH) is a destination; a case in which an occupancy rate of a buffer queue in a direction of the second-best next-hop satellite (SBH) is equal to or greater than a predetermined threshold; and a case in which the second-best next-hop satellite (SBH) is a satellite on a previous path through which the data packet has been transmitted.

16. A non-transitory computer-readable recording medium having instructions stored thereon that, when executed by one or more processors, cause the one or more processors to perform the distributed routing method of claim 9.
